(19) United States
(12) Patent Application Publication
(10) Pub. No.: US 2011/0309070 A1
(43) Pub. Date: Dec. 22, 2011

(54) METHOD AND DEVICE FOR HEATING ACCUMULATOR CELLS

(76) Inventor: Stefan Butzmann, Beilstein (DE)

(21) Appl. No.: 13/202,420

(22) PCT Filed: Jan. 14, 2010
(86) PCT No.: PCT/EP2010/050392

§ 371 Date: Sep. 8, 2011

(30) Foreign Application Priority Data
Feb. 20, 2009 (DE) 10 2009 001 047.5

(51) Int. Cl. H05B 6/10; H05B 6/06; H05B 6/02

(52) U.S. Cl. 219/663; 219/600; 219/661

(57) ABSTRACT

The invention relates to a method for heating accumulator cells of an electrical energy accumulator, at least one first accumulator cell and at least one second accumulator cell being arranged in series. According to the invention, the first accumulator cell and the second accumulator cell alternately feed at least one inductive component which is electrically connected to an intermediate tap between the first and second accumulator cells. The invention also relates to a corresponding device.

The invention relates to a method for heating accumulator cells of an electrical energy accumulator, in which at least a first of the accumulator cells and at least a second of the accumulator cells are connected in series.

### PRIOR ART

A method for heating accumulator cells of an electrical energy accumulator, for instance for heating the electrical energy accumulator, embodied as rechargeable batteries, of a hybrid or electrical vehicle is known.

Since even in temperate latitudes—for instance on cold winter days—outdoor temperatures below 0° C. occur, under those conditions the batteries must first be heated so they can produce the full power demanded. Until now, the battery cells disposed in a vehicle have been tempered, or in other words heated or cooled, by means of an air conditioning system of the vehicle or by means of a separate coolant system.

To attain the amounts of power or energy required and the requisit voltage by means of the energy accumulator, individual accumulator cells are connected in series and sometimes also in parallel.

### DISCLOSURE OF THE INVENTION

According to the invention, it is provided that in the first accumulator cell and the second accumulator cell in alternation supply at least one inductive component connected electrically to an intermediate tap between the first and second accumulator cells. This makes use of the fact that the inductive component has an ohmic resistance the quantity of which is less than the quantity of a first internal resistor of the first accumulator cell and also less than the quantity of a second internal resistor of the second accumulator cell. In particular, the quantity of the first internal resistor—at least at a temperature of the energy accumulator of below 0° C.—is at least 10 times greater than the quantity of the ohmic resistance of the inductive component, and the quantity of the second internal resistor is also at least 10 times greater than the quantity of the ohmic resistance of the inductive component. In the context of this patent application, the term electrical energy accumulator is understood to mean a charge reservoir, magnetic reservoir, and/or electrochemical energy reservoir.

The method has the advantage that—aside from the energy required for the desired raising of the temperature (that is, heating) of the electrical energy accumulator—it involves only minimal energy losses.

The electrical energy accumulator is in particular a rechargeable battery, preferably a lithium-ion battery, with battery cells as accumulator cells. In an electrical energy accumulator embodied as a battery, the fact that the internal resistor increases with decreasing temperature is additionally utilized.

In particular, it is provided that a plurality of first accumulator cells and a plurality of second accumulator cells are each connected in series. Thus the series-connected first accumulator cells and the series-connected second accumulator cells in alternation supply current to at least one inductive component connected electrically to the intermediate tap between the first and second accumulator cells.

In a preferred embodiment of the invention, it is provided that the number of first accumulator cells and the number of second accumulator cells are the same. If all the accumulator cells have the same cell voltage, then the first accumulator cells and the second accumulator cells can simultaneously build up a quantitatively equally strong magnetic field in the inductive component.

It is advantageously provided that the change in the supply of current is effected by switching at least one transistor. The switch is in particular a transistor, preferably a bipolar transistor or a field-effect transistor, and especially preferably a MOSFET (metal oxide semiconductor field-effect transistor), an IGBT (insulated-gate bipolar transistor), and/or a thyristor.

In a preferred embodiment of the invention, the change in the supply of current is effected by opening and closing two switches, of which the first switch electrically connects the first accumulator cell or first accumulator cells and the second switch electrically connects the second accumulator cell or second accumulator cells to the inductive component. The two switches are embodied in particular as transistors.

In particular, the method has the following steps:
closing the one transistor when the other transistor is open, whereupon a rising current flows through the inductive component, the one transistor, and the accumulator cell associated with that accumulator cell; and
opening the one accumulator cell and simultaneously closing the other transistor when a predetermined current threshold quantity is reached, whereupon the current through the inductive component, the other transistor and the accumulator cell associated with the other transistor decreases and then builds up again, with a reversed sign, until the current threshold quantity is reached again.

The procedure can be repeated in the opposite direction, that is, by switching off the other transistor and switching on the first transistor. The currents that in this method flow through the accumulator cells of the electrical energy accumulator lead to heating of the electrical energy accumulator as a result of the power loss in the internal resistors of the accumulator cells.

The invention further relates to a device for heating accumulator cells of an electrical energy accumulator, in particular a device for performing a method as defined above, in which at least a first of the accumulator cells and at least a second of the accumulator cells are connected in series. According to the invention, the device has at least one switch and at least one inductive component connected electrically to an intermediate tap between the first and second accumulator cells, and the inductive component is supplied with current by switching the switch in alternation from the first or the second accumulator cell. If only a single switch is provided, then the switching is a switchover, and/or switching on and off (opening and closing the switch). The switch or switches are preferably embodied as a transistor or transistors, respectively.

The electrical energy accumulator is in particular embodied as a rechargeable battery, preferably a lithium-ion battery, and the accumulator cells are embodied as battery cells.

In a preferred embodiment of the invention, it is provided that a plurality of first accumulator cells and a plurality of second accumulator cells are each connected in series. In order for the energy accumulator to have the requisite power and energy data, individual accumulator cells are connected in series and some of them are additionally connected in parallel. Preferably, the number of first accumulator cells and the number of second accumulator cells are the same.

In a preferred embodiment of the invention, it is provided that the change in the supply of current is effected by opening and closing two switches, of which the first switch electrically connects the first accumulator cell and the second switch electrically connects the second accumulator cell to the inductive component.

Finally, it is advantageously provided that the device has a control and/or regulating device, which triggers the at least one switch for controlling and/or regulating the current through the inductive component.

The invention will be described in further detail below in conjunction with the associated drawings. In the drawings:

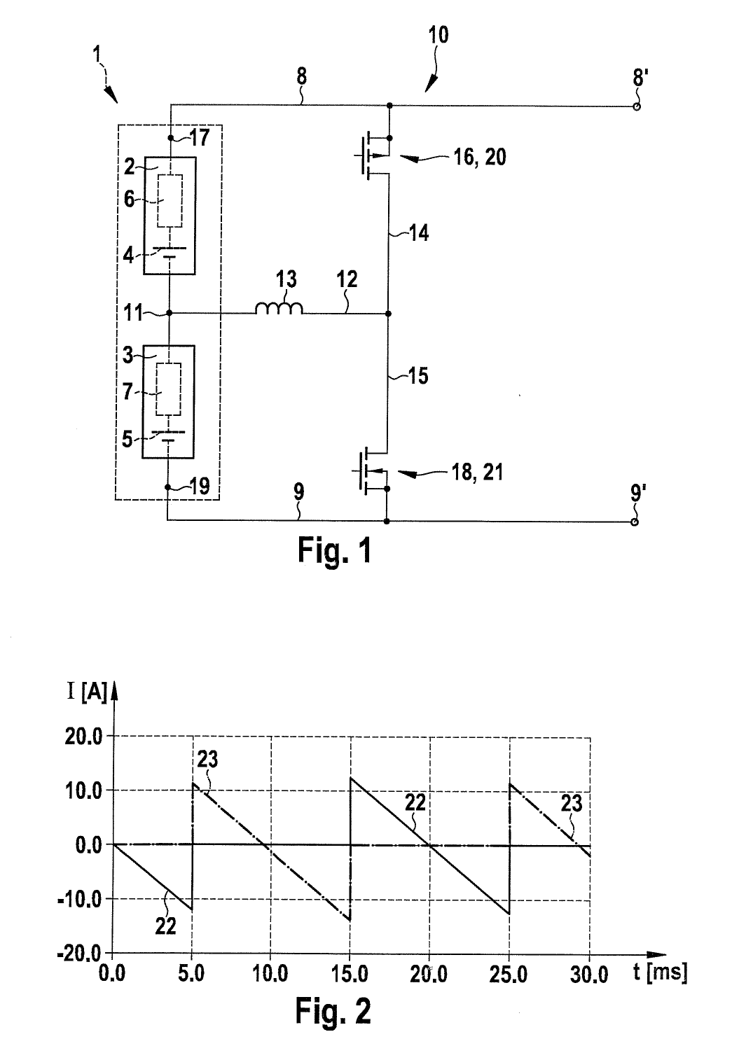

FIG. 1 shows a circuit arrangement, having an electrical energy accumulator with two accumulator cells, and a device for heating these accumulator cells, in one embodiment of the invention; and

FIG. 2 is a graph, in which the time-dependent current courses through a first current branch having a first switch and through a second current branch having a second switch are plotted over time.

FIG. 1 shows a circuit arrangement, having an energy accumulator 1 which has two series-connected accumulator cells 2, 3. In the substitute circuit diagram shown here, each of the accumulator cells 2, 3 has a respective ideal voltage source 4, 5 and each has an internal ohmic resistor 6, 7. The electrical energy accumulator 1 can be connected to an electrical power network, not shown, via leads 8, 9 and terminals 8′, 9′. If for example the electrical energy accumulator 1 is the energy accumulator of an electrical drive of an electric vehicle or hybrid vehicle, then the power network is the on-board traction electrical system of that vehicle.

The circuit arrangement shown in FIG. 1 also has a device 10 for heating the accumulator cells 2, 3 of the electrical energy accumulator 1. The device 1 has a current path 12, which is connected electrically to an intermediate tap and in which an inductive component 13 is disposed. At the intermediate tap 11, the intermediate potential applied between the two accumulator cells 3 is tapped. The current path 12 branches out, on a side facing the intermediate tap 11, into a first current branch 14 and a second current branch 15. A first switch 16 is disposed in the first current branch 14. If the first switch is closed, the result is a first circuit from a first terminal 17 (positive pole) of the electrical energy accumulator 1 via the first lead 8, the first current branch 14 having the first switch 16, and the current path 12 having the inductive component 13, and via the intermediate tap 11 to the first accumulator cell 2 of the electrical energy accumulator 1. A second switch 18 is disposed in the second current branch 15. If the second switch 18 is closed, the result is a second circuit from the intermediate tap 11, via the current path 12 having the inductive component 13 and the second lead 18, to a second terminal 19, which is connected via the second accumulator cell 3 to the intermediate tap 11. The first switch 16 is embodied as a first transistor 20, and the second switch 18 is embodied as a second transistor 21.

FIG. 2 shows a corresponding graph, in which the time-dependent current course 22 of the current I through the first current branch 14 and the time-dependent current course 23 of the current I through the second current branch 15 are plotted over the time t.

The result is the following function of the device 10 for heating the accumulator cells 2, 3 of the electrical energy accumulator 1: For operating the electrical energy accumulator 1 at low temperatures, first, with the second transistor 21 open, the first transistor is closed (in the example of FIG. 2, at time t=0.0 ms). An increasing current I then flows (current course 22 in FIG. 2) in the first current branch 14 through the inductive component 13 in the current path 12 via the first transistor 20 to the second terminal 19 (negative pole) embodied as ground. If, once a current threshold quantity (12 amperes in FIG. 2) is reached, the first transistor 20 is opened, or in other words switched to the non-conducting state, and if simultaneously or shortly thereafter the second transistor 21 is switched to be conducting (in the example of FIG. 2, at time t=5.0 ms,), then the current flows through the inductive component 13 via the second transistor 21 and the second current branch 15 (current course 23 in FIG. 2). As long as the second transistor 21 is not yet conducting, the current I flows via the reverse diode, not shown, of the second transistor 21. In that phase, the current through the inductive component 13 drops again. If the second transistor remains conducting beyond the time when the current is 0 (I=0 at time t=9.0ms), then the current I through the inductive component 13 reverses, and the procedure can be repeated in the opposite direction, in other words with shutoff of the second transistor 21 and switching on of the first transistor 20 (in the example of FIG. 2, at time t=15.0 ms at a current threshold quantity of 12 amperes). The currents that in this method flow through the accumulator cells 2, 3 of the electrical energy accumulator 1 lead to thermal losses at the internal resistors 6, 7 of the accumulator cells 2, 3, and these losses cause heating of the electrical energy accumulator 1. Simultaneously, as a result of the buffer storage of energy in the inductive component 13 outside the accumulator cells 2, 3, the desired temperature increase is attained with only minimal expenditure of energy.

1-11. (canceled)

12. A method for heating accumulator cells of an electrical energy accumulator, comprising:
connecting at least a first of the accumulator cells and at least a second of the accumulator cells in series, and
supplying, via the first accumulator cell and the second accumulator cell in alternation, at least one inductive component connected electrically to an intermediate tap between the first accumulator cell and the second accumulator cell.

13. The method as defined by claim 12, wherein a plurality of first accumulator cells and a plurality of second accumulator cells are each connected in series.

14. The method as defined by claim 12, wherein a change in a supply of current is effected by switching at least one switch.

15. The method as defined by claim 13, wherein a change in a supply of current is effected by switching at least one switch.

16. The method as defined by claim 14, wherein the at least one switch is embodied as a transistor.

17. The method as defined by claim 15, wherein the at least one switch is embodied as a transistor.

18. The method as defined by claim 12, wherein a change in a supply of current is effected by opening and closing two switches, of which a first switch electrically connects the first accumulator cell and a second switch electrically connects the second accumulator cell to the inductive component.

19. The method as defined by one of the foregoing claims 16, further comprising:
closing a first transistor when a second transistor is open, whereupon a rising current flows through the inductive component, the first transistor, and the first accumulator cell associated with the first transistor; and
opening the first transistor and simultaneously closing the second transistor when a predetermined current threshold quantity is reached, whereupon the current through the inductive component, the second transistor, and the second accumulator cell associated with the second transistor decreases and then builds up again, with a reversed sign, until the current threshold quantity is reached again.

20. The method as defined by one of the foregoing claims 17, further comprising:
closing a first transistor when a second transistor is open, whereupon a rising current flows through the inductive component, the first transistor, and the first accumulator cell associated with the first transistor; and
opening the first transistor and simultaneously closing the second transistor when a predetermined current threshold quantity is reached, whereupon the current through the inductive component, the second transistor, and the second accumulator cell associated with the second transistor decreases and then builds up again, with a reversed sign, until the current threshold quantity is reached again.

21. A device for heating accumulator cells of an electrical energy accumulator, in particular a device for performing a method as defined by claim 12, in which at least a first of the accumulator cells and at least a second of the accumulator cells are connected in series, at least one switch and at least one inductive component are connected electrically to an intermediate tap between the first accumulator cell and the second accumulator cell, and the inductive component is supplied with current by switching the at least one switch in alternation from the first accumulator cell or the second accumulator cell.

22. The device as defined by claim 21, wherein a plurality of first accumulator cells and a plurality of second accumulator cells are each connected in series.

23. The device as defined by claim 21, wherein a number of first accumulator cells and a number of second accumulator cells are equal.

24. The device as defined by claim 22, wherein a number of first accumulator cells and a number of second accumulator cells are equal.

25. The device as defined by claim 21, wherein a change in the supply of current is effected by opening and closing two switches, of which a first switch electrically connects the first accumulator cell and a second switch electrically connects the second accumulator cell to the inductive component.

26. The device as defined by claim 22, wherein a change in the supply of current is effected by opening and closing two switches, of which a first switch electrically connects the first accumulator cell and a second switch electrically connects the second accumulator cell to the inductive component.

27. The device as defined by claim 23, wherein a change in the supply of current is effected by opening and closing two switches, of which a first switch electrically connects the first accumulator cell and a second switch electrically connects the second accumulator cell to the inductive component.

28. The device as defined by claim 21, having a control and/or regulating device, which triggers the at least one switch, for controlling and/or regulating the current through the inductive component.

29. The device as defined by claim 22, having a control and/or regulating device, which triggers the at least one switch, for controlling and/or regulating the current through the inductive component.

30. The device as defined by claim 23, having a control and/or regulating device, which triggers the at least one switch, for controlling and/or regulating the current through the inductive component.

31. The device as defined by claim 25, having a control and/or regulating device, which triggers the at least one switch, for controlling and/or regulating the current through the inductive component.
